(19) United States
(12) Patent Application Publication
(10) Pub. No.: US 2016/0065392 A1
(43) Pub. Date: Mar. 3, 2016

(54) MOBILE TERMINAL

(71) Applicant: Spreadtrum Communications (Shanghai) Co., Ltd., Zhangjiang (CN)

(72) Inventors: Shanyi XIE, Zhangjiang (CN); Wentao HUANG, Zhangjiang (CN); Guotao ZHAO, Zhangjiang (CN)

(21) Appl. No.: 14/643,229

(22) Filed: Mar. 10, 2015

(30) Foreign Application Priority Data
Aug. 29, 2014 (CN) 201410438524.9

(51) Int. Cl. H04L 25/02; H04J 13/00; H04B 7/04

(52) U.S. Cl. CPC H04L 25/0294; H04B 7/0413; H04J 13/00

(57) ABSTRACT

A mobile terminal is provided. The mobile terminal includes: a base band processor; a main RF transceiver electrically coupled to the base band processor; a Balun unit adapted to receive single-ended RF signals, and convert the single-ended RF signals whose frequencies are within a preset range into differential RF signals; and a diversity RF receiver electrically coupled to the base band processor and the Balun unit, which is adapted to receive the differential RF signals converted by the Balun unit and process the differential RF signals to generate baseband signals to be processed by the base band processor. Accordingly, components required by a mobile terminal and cost of the mobile terminal can be reduced.

### CROSS-REFERENCE TO RELATED APPLICATIONS

The present invention claims priority under 35 U.S.C. §119 to Chinese Application No. 201410438524.9, filed Aug. 29, 2014, the entire content of which is incorporated herein by reference.

### TECHNICAL FIELD

The present disclosure generally relates to wireless communication, and more particularly, to a mobile terminal.

### BACKGROUND

Long Term Evolution (LTE) is based on the Universal Mobile Telecommunications System (UMTS) network technologies and is developed by the 3rd Generation Partnership Project (3GPP). Nowadays, as one of the wireless communication technologies, LTE has been widely used.

Receive Diversity and Multi-input Multi-output (MIMO) are core technologies in the LTE. When the Receive Diversity or the MIMO technology is applied, at least two sets of receive path, including an antenna and a corresponding receiver, as well as other components, for receiving signals, are required to improve the communication quality and performance. Evolution edition for Wideband Code Division Multiple Access (WCDMA) standard supports the Diversity Reception and the MIMO technologies.

Regarding a LTE mobile terminal or a WCDMA mobile terminal, which applies the Receive Diversity and the MIMO technologies, a diversity RF receiver is required. Furthermore, a Surface Acoustic Wave (SAW) filter is required for each frequency band of the LTE standard or each frequency band of the WCDMA standard, so as to filter out unwanted interferers. For example, when a LTE mobile terminal supports a number of frequency bands, such as five frequency bands, then five standalone SAW filters are required. Accordingly, as price of the SAW filter is high, cost of a mobile terminal with a number of such SAW filters will increase.

### SUMMARY

According to one embodiment of the present disclosure, a mobile terminal is provided, including: a base band processor; a main RF transceiver electrically coupled to the base band processor; a Balun unit adapted to receive single-ended RF signals, and a diversity RF receiver electrically coupled to the base band processor and the Balun unit, which is adapted to receive the differential RF signals converted by the Balun unit and process the differential RF signals to generate baseband signals to be processed by the base band processor.

In some embodiments, the diversity RF receiver includes a first stage low-noise amplifier which is adapted to amplify the differential RF signals.

In some embodiments, the Balun unit includes two or more Balun devices.

In some embodiments, the single-ended RF signals include LTE signals.

In some embodiments, the Balun unit includes a first Balun device and a second Balun device, where the first Balun device is adapted to convert the LTE signals within a high frequency domain into first differential signals, and the second Balun device is adapted to convert the LTE signals within an intermediate frequency domain into second differential signals.

In some embodiments, the LTE signals within the high frequency domain include: TD-LTE signals having a frequency band identification of 40, TD-LTE signals having a frequency band identification of 41, TD-LTE signals having a frequency band identification of 38, and FDD-LTE signals having a frequency band identification of 7.

In some embodiments, the LTE signals within the intermediate frequency domain include: TD-LTE signals having a frequency band identification of 39, and FDD-LTE signals having a frequency band identification of 3.

In some embodiments, the single-ended RF signals include WCDMA signals.

In some embodiments, the Balun unit includes a third Balun device and a fourth Balun device, where the third Balun device is adapted to convert the WCDMA signals within an intermediate frequency domain into third differential signals, and the fourth Balun device is adapted to convert the WCDMA signals within a low frequency domain into fourth differential signals.

In some embodiments, the WCDMA signals within the intermediate frequency domain include: WCDMA signals having a frequency band identification of 1, and WCDMA signals having a frequency band identification of 2.

In some embodiments, the WCDMA signals within the low frequency domain include: WCDMA signals having a frequency band identification of 5, and WCDMA signals having a frequency band identification of 8.

### BRIEF DESCRIPTION OF THE DRAWINGS

FIG. 1 schematically illustrates a structure of a mobile terminal according to one embodiment of the present disclosure;

FIG. 2 schematically illustrates a structure of a LTE mobile terminal according to one embodiment of the present disclosure; and

FIG. 3 schematically illustrates a structure of a WCDMA mobile terminal according to one embodiment of the present disclosure.

### DETAILED DESCRIPTION

In order to clarify the objects, characteristics and advantages of the present disclosure, embodiments of the present disclosure will be described in detail in conjunction with the accompanying drawings. The disclosure will be described with reference to certain embodiments. Accordingly, the present disclosure is not limited to the embodiments disclosed. It will be understood by those skilled in the art that various changes may be made without departing from the spirit or scope of the disclosure.

As recited in the background, existing LTE mobile terminals or WCDMA mobile terminals, which apply Diversity Reception and MIMO technologies, require at least one pair of antennas and correspondingly two sets of receivers for receiving signals. Furthermore, a Surface Acoustic Wave (SAW) filter is required for each frequency band of the LTE standard or each frequency band of the WCDMA standard. Therefore, standalone SAW filters required have a number equal to that of the frequency bands. Accordingly, as price of the SAW filter is high, cost of a mobile terminal with a number of such SAW filters will be increased.

In present disclosure, Balun (Balanced-Unbalanced transformer) devices instead of SAW filters are applied. Accordingly, more than one frequency bands may use one common Balun device. Further, price of one single Balun device is lower than that of one SAW filter. Therefore, cost of the mobile terminal can be reduced.

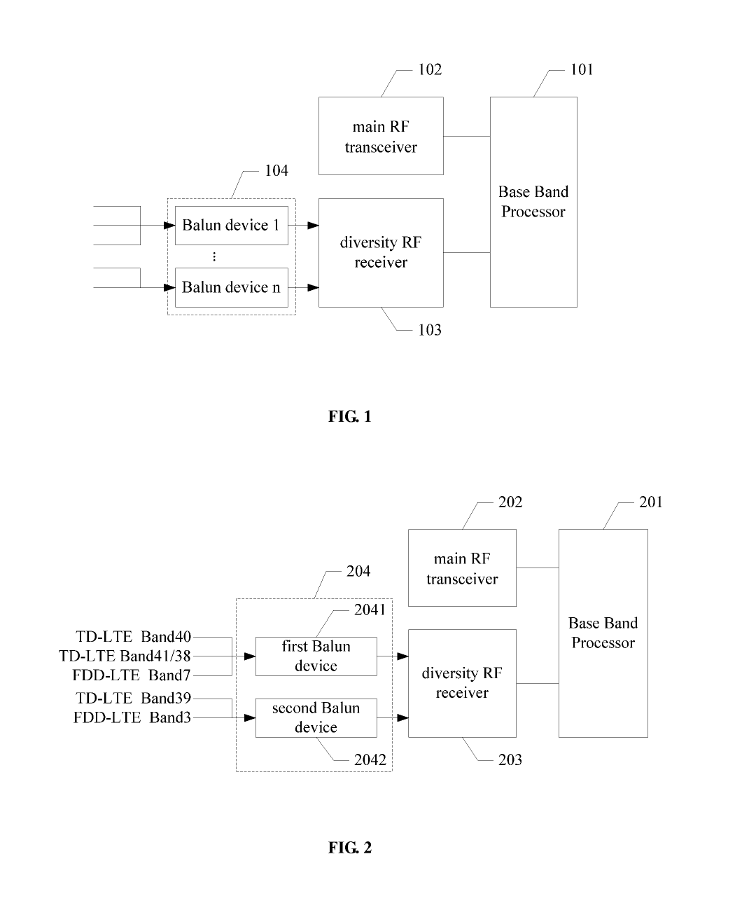

Referring to FIG. 1, a mobile terminal according to one embodiment of the present disclosure is provided. The mobile terminal includes: a base band processor 101, a main RF (Radio Frequency) transceiver 102, a diversity RF receiver 103, and a Balun unit 104 including a plurality of Balun devices.

The main RF transceiver 102 is electrically coupled with the base band processor 101. In some embodiments, the main RF transceiver 102 is used for receiving and sending signals. Specifically, the main RF transceiver 102 is configured to: process RF signals received by antennas (not shown in FIG. 1) to generate baseband signals, and send the baseband signals to the base band processor 101, where the baseband signals are adapted to be processed by the base band processor 101. The main RF transceiver 102 is further configured to: process signals generated by the base band processor 101 to generate RF signals, and send RF signals to the antennas, where the RF signals are adapted to be sent by the antennas.

The diversity RF receiver 103 is electrically coupled with the Balun unit 104 and the base band processor 101. The Balun unit 104 is electrically coupled with a match circuit disposed on a terminal of the antennas. The Balun unit 104 is configured to: receive single-ended RF signals which are received by the antennas and passed though the match circuit; convert the single-ended RF signals received into differential RF signals; and send the differential RF signals to the diversity RF receiver 103.

The diversity RF receiver 103 is configured to: receive the differential RF signals converted by the Balun unit 104, and process the differential RF signals received to generate baseband signals that can be processed by the base band processor 101, and input the baseband signals generated to the base band processor 101. In some embodiments, processing the differential RF signals may include: implementing a low-noise amplifying process to the differential RF signals, implementing a filtering process to the differential RF signals, implementing a frequency mixing process to the differential RF signals, implementing a demodulation process to the differential RF signals, and so on.

In some embodiments, the single-ended RF signals whose operating frequencies are within a preset range may be converted into the differential RF signals by one common Balun device of the Balun unit 104. For example, supposing a first frequency band 40 has a downlink frequency ranging from 2300 MHz to 2400 MHz, a second frequency band 41 has a downlink frequency ranging from 2496 MHz to 2690 MHz, and the preset range is from 2300 MHz to 2800 MHz, thus single-ended RF signals of the first frequency band 40 and the single-ended RF signals of the second frequency band 41 can be converted into differential RF signals by one common Balun device. It should be noted that, the Balun unit 104 of the mobile terminal may include two, three, or more Balun devices, which may be set according to actual requirements.

In some embodiments, the preset range may be between 500 MHz and 1000 MHz. In some embodiments, the preset range may be between 1500 MHz and 2400 MHz. In some embodiments, the preset range may be between 2300 MHz and 2800 MHz. The preset range can be set according to actual applications.

In some embodiments, an adjustment to structure of the diversity RF receiver 103 may be required, so that the diversity RF receiver 103 is able to process the differential RF signals being converted by the Balun unit 104. Specifically, the differential RF signals may be received along with large interferer signals, and an existing first stage low-noise amplifier of the diversity RF receiver 103 may have a narrow dynamic range, thus the first stage low-noise amplifier does not function normally and can not be used to amplify the differential RF signals. Therefore, the first stage low-noise amplifier of the diversity RF receiver 103 may be adjusted to have a wide dynamic range, so that the differential RF signals can be amplified.

Accordingly, one common Balun device is used for converting single-ended RF signals whose frequencies are within a preset range into differential RF signals. Thus, it is unnecessary to utilize a SAW filter for signals of each frequency band. Further, cost of the Balun device is lower than that of the SAW filter. Therefore, cost of the mobile terminal is able to be effectively reduced. It should be noted that, the number of Balun devices included in the Balun unit 104 as shown in FIG. 1 is just for illustration, in some embodiments, the Balun unit 104 may only include one Balun device.

Referring to FIG. 2, a LTE mobile terminal according to one embodiment of the present disclosure is illustrated. The LTE mobile terminal includes: a base band processor 201, a main RF transceiver 202, a diversity RF receiver 203, and a Balun unit 204. The base band processor 201, the main RF transceiver 202, and the diversity RF receiver 203 are similar to the base band processor 101, the main RF transceiver 102, and the diversity RF receiver 103 as recited above regarding to FIG. 1.

In some embodiments, TD-LTE (Time Division Long Term Evolution) signals which has a frequency band identification of 40 (that is, TD-LTE Band 40) has a downlink frequency ranging from 2300 MHz to 2400 MHz. TD-LTE signals which has a frequency band identification of 41 (that is, TD-LTE Band 41) has a downlink frequency ranging from 2496 MHz to 2690 MHz. TD-LTE signals which has a frequency band identification of 38 (that is, TD-LTE Band 38) has a downlink frequency ranging from 2570 MHz to 2620 MHz. FDD-LTE (Frequency Division Duplex Long Term Evolution) signals which has a frequency band identification of 7 (that is, FDD-LTE Band 7) has a downlink frequency ranging from 2500 MHz to 2570 MHz. TD-LTE signals which has a frequency band identification of 39 (that is, TD-LTE Band 39) has a downlink frequency ranging from 1880 MHz to 1920 MHz. FDD-LTE signals which has a frequency band identification of 3 (that is, FDD-LTE Band 3) has a downlink frequency ranging from 1805 MHz to 1880 MHz.

In some embodiments, LTE signals are divided into a high frequency domain and an intermediate frequency domain according to the downlink frequencies. Signals in the high frequency domain includes: TD-LTE signals having a frequency band identification of 40, TD-LTE signals having a frequency band identification of 41, TD-LTE signals having a frequency band identification of 38, and FDD-LTE signals having a frequency band identification of 7. Signals in the intermediate frequency domain include: TD-LTE signals having a frequency band identification of 39, and FDD-LTE signals having a frequency band identification of 3.

In some embodiments, the Balun unit 204 include: a first Balun device 2041 and a second Balun device 2042. The first Balun device 2041 is adapted to convert the single-ended RF signals within the high frequency domain into corresponding differential RF signals, and send the differential RF signals into the diversity RF receiver. The single-ended RF signals within the high frequency domain may include: TD-LTE Band 40, TD-LTE Band 41, TD-LTE Band 38, and FDD-LTE Band 7. The second Balun device 2042 is adapted to convert the single-ended RF signals within the intermediate frequency domain into corresponding differential RF signals, and send the differential RF signals into the diversity RF receiver. The single-ended RF signals within the intermediate frequency domain may include: TD-LTE Band 39, and FDD-LTE Band 3.

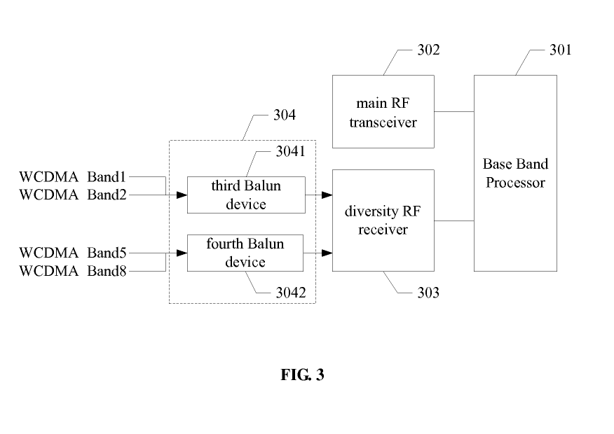

Referring to FIG. 3, a WCDMA mobile terminal according to one embodiment of the present disclosure is illustrated. The WCDMA mobile terminal includes: a base band processor 301, a main RF transceiver 302, a diversity RF receiver 303, and a Balun unit 304. The base band processor 301, the main RF transceiver 302, and the diversity RF receiver 303 are similar to the base band processor 101, the main RF transceiver 102, and the diversity RF receiver 103 as recited above regarding to FIG. 1.

In some embodiments, WCDMA signals which has a frequency band identification of 1 (that is, WCDMA Band 1) has a downlink frequency ranging from 2110 MHz to 2170 MHz. WCDMA signals which has a frequency band identification of 2 (that is, WCDMA Band 2) has a downlink frequency ranging from 1930 MHz to 1990 MHz. WCDMA signals which has a frequency band identification of 5 (that is, WCDMA Band 5) has a downlink frequency ranging from 869 MHz to 894 MHz. WCDMA signals which has a frequency band identification of 8 (that is, WCDMA Band 8) has a downlink frequency ranging from 925 MHz to 960 MHz.

In some embodiments, WCDMA signals are divided into signals in an intermediate frequency domain and signals in a low frequency domain according to the downlink frequencies. Signals in the intermediate frequency domain includes: WCDMA signals having a frequency band identification of 1 (WCDMA Band 1), and WCDMA signals having a frequency band identification of 2 (WCDMA Band 2). Signals in the low frequency domain includes: WCDMA signals having a frequency band identification of 5 (WCDMA Band 5), and WCDMA signals having a frequency band identification of 8 (WCDMA Band 8).

In some embodiments, the Balun unit 304 include: a third Balun device 3041 and a fourth Balun device 3042. The third Balun device 3041 is adapted to convert the single-ended RF signals within the intermediate frequency domain into corresponding differential RF signals, and send the differential RF signals into the diversity RF receiver. The fourth Balun device 3042 is adapted to convert the single-ended RF signals within the low frequency domain into corresponding differential RF signals, and send the differential RF signals into the diversity RF receiver.

Accordingly, in a mobile terminal, such as LTE mobile terminal or WCDMA mobile terminal, only two Balun devices are required to convert single-ended RF signals into differential RF signals. Thus, numbers of components in the mobile terminal, and an area of a printed circuit board (PCB) required are both reduced. Furthermore, only two Balun devices, instead of a plurality of SAW filters, are coupled to the diversity RF receiver, thus connecting terminals of the diversity RF receiver required can be reduced.

Although the present disclosure has been disclosed above with reference to preferred embodiments thereof, it should be understood by those skilled in the art that various changes may be made without departing from the spirit or scope of the disclosure. Accordingly, the present disclosure is not limited to the embodiments disclosed.

What is claimed is:

1. A mobile terminal, comprising:
a base band processor;
a main RF transceiver electrically coupled to the base band processor;
a Balun unit adapted to receive single-ended RF signals, and convert the single-ended RF signals whose operating frequencies are within a preset range into differential RF signals; and
a diversity RF receiver electrically coupled to the base band processor and the Balun unit, which is adapted to receive the differential RF signals converted by the Balun unit and process the differential RF signals to generate baseband signals to be processed by the base band processor.

2. The mobile terminal according to claim 1, wherein the diversity RF receiver comprises a first stage low-noise amplifier which is adapted to amplify the differential RF signals.

3. The mobile terminal according to claim 1, wherein the Balun unit comprises two or more Balun devices.

4. The mobile terminal according to claim 3, wherein the single-ended RF signals comprise LTE signals.

5. The mobile terminal according to claim 4, wherein the Balun unit comprises a first Balun device and a second Balun device, where the first Balun device is adapted to convert the LTE signals within a high frequency domain into first differential signals, and the second Balun device is adapted to convert the LTE signals within an intermediate frequency domain into second differential signals.

6. The mobile terminal according to claim 5, the LTE signals within the high frequency domain comprise: TD-LTE signals having a frequency band identification of 40, TD-LTE signals having a frequency band identification of 41, TD-LTE signals having a frequency band identification of 38, and FDD-LTE signals having a frequency band identification of 7.

7. The mobile terminal according to claim 5, the LTE signals within the intermediate frequency domain comprise: TD-LTE signals having a frequency band identification of 39, and FDD-LTE signals having a frequency band identification of 3.

8. The mobile terminal according to claim 3, wherein the single-ended RF signals comprise WCDMA signals.

9. The mobile terminal according to claim 8, wherein the Balun unit comprises a third Balun device and a fourth Balun device, where the third Balun device is adapted to convert the WCDMA signals within an intermediate frequency domain into third differential signals, and the fourth Balun device is adapted to convert the WCDMA signals within a low frequency domain into fourth differential signals.

10. The mobile terminal according to claim 9, the WCDMA signals within the high frequency domain comprise: WCDMA signals having a frequency band identification of 1, and WCDMA signals having a frequency band identification of 2.

11. The mobile terminal according to claim 9, the WCDMA signals within the intermediate frequency domain comprise: WCDMA signals having a frequency band identification of 5, and WCDMA signals having a frequency band identification of 8.
